(19) United States
(12) Patent Application Publication
(10) Pub. No.: US 2023/0264442 A1
(43) Pub. Date: Aug. 24, 2023

(54) DISPENSING SYSTEM

(71) Applicant: Apple Inc., Cupertino, CA (US)

(72) Inventors: Anna V. MIRABELLA, Palo Alto, CA (US); Forrest C. WANG, Petaluma, CA (US); Andreas G. WEBER, Los Altos, CA (US); Duco B. PASMOOIJ, Los Altos, CA (US)

(21) Appl. No.: 18/136,804

(22) Filed: Apr. 19, 2023

Related U.S. Application Data
(63) Continuation of application No. 18/104,675, filed on Feb. 1, 2023, now abandoned.
Application No. 18/104,675 is a continuation of application No. PCT/US2021/041450, filed on Jul. 13, 2021.
(60) Provisional application No. 63/060,589, filed on Aug. 3, 2020.

(51) Int. Cl. B29D 11/00; G02B 27/01; G06Q 30/0601; G06Q 20/20

(52) U.S. Cl. CPC B29D 11/00961; G02B 27/0101; G02B 27/0172; G06Q 20/20; G06Q 30/0621; G06Q 30/0643; G02B 2027/0138; G02B 2027/014

(57) ABSTRACT

Different users of head-mountable devices have different needs for vision correction. A system can be provided to determine the corrective lenses that are most appropriate for a given user. A dispenser can contain a variety of different lenses that provide different types of vision correction. The dispenser can provide an appropriate one of the lenses, and a user can use the lens with a head-mountable device during a sampling session. During the sampling session, the user can verify that the lens is satisfactory.

### CROSS-REFERENCE TO RELATED APPLICATION

This application is a continuation of U.S. 0. Application No. 18/104,675, entitled “DISPENSING SYSTEM,” filed Feb. 1, 2023, which is a continuation of International Patent Application No. PCT/US2021/041450, entitled “DISPENSING SYSTEM,” filed Jul. 13, 2021, which claims the benefit of U.S. Provisional Application No. 63/060,589, entitled “DISPENSING SYSTEM,” filed Aug. 3, 2020, the entirety of each of which is incorporated herein by reference.

### TECHNICAL FIELD

The present description relates generally to dispensing systems, including to dispensing system for components for use with head-mountable devices.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user’s head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example environment in which an HMD demonstration system may be implemented in accordance with one or more implementations.

FIG. 2 illustrates a flow diagram of an example process for an input device in accordance with one or more implementations.

FIG. 3 illustrates a flow diagram of an example process for a dispenser in accordance with one or more implementations.

FIG. 4 illustrates a flow diagram of an example process for a head-mountable device in accordance with one or more implementations.

FIG. 5 illustrates an example network environment in which an HMD demonstration system may be implemented in accordance with one or more implementations.

FIG. 6 illustrates an example electronic device that may be used in a HMD demonstration system in accordance with one or more implementations.

FIG. 7 illustrates a top view of a head-mountable device and lens device, according to some embodiments of the present disclosure.

FIG. 8 illustrates a top view of the head-mountable device of FIG. 7 with the lens device of FIG. 7 installed therein, according to some embodiments of the present disclosure.

FIG. 9 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device.

The visual output features of a head-mountable device can be provided in a manner that accommodates a user’s vision, including vision deficiencies and/or needs for vision correction. For example, a head-mountable device can include or be combinable with corrective lenses that allow a user to properly view the visual output features of the head-mountable device. To allow a given head-mountable device can be used by different users, the corrective lenses can be provided as a separate module that is attachable, removable, and/or exchangeable with other corrective lenses. Accordingly, any given user can properly view the visual output features when using the head-mountable device with an appropriate corresponding set of corrective lenses.

It can be desirable to allow a user to determine which of various lenses are appropriate for use with a head-mountable device, be provided with the appropriate lenses, sample the lenses, and make a purchase if satisfied. Where provided in combination, such abilities can facilitate a user’s decision-making process when seeking a head-mountable device and corresponding components.

Different users of head-mountable devices have different needs for vision correction. Systems and methods can be provided to determine the corrective lenses that are most appropriate for a given user. Such systems and methods can include an input device for determining which of a variety of existing corrective lenses are appropriate for a given user. A dispenser can provide a selected one of multiple lenses for use by a user with a head-mountable device. The head-mountable device can then be operated with the lenses, including any appropriate accommodations based on the selection of the lenses.

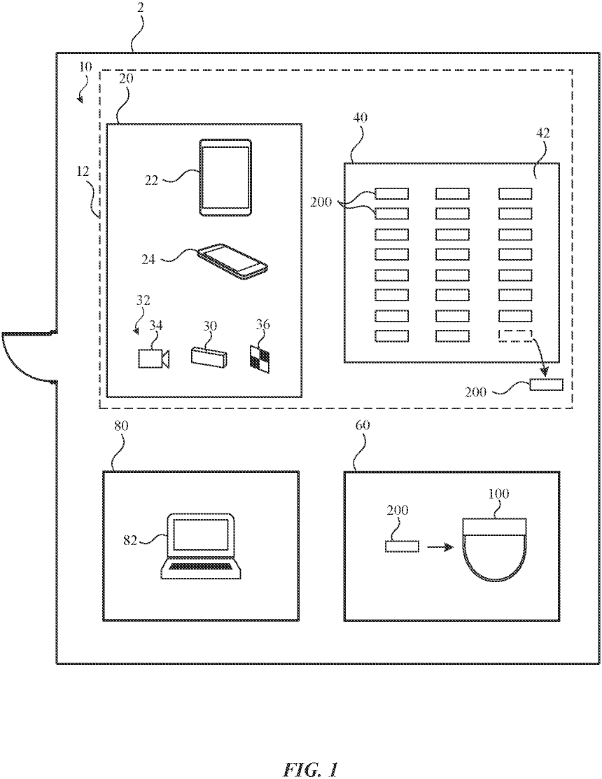

These and other embodiments are discussed below with reference to FIGS. 1-9. However, those skilled in the art will readily appreciate that the detailed description given herein with respect to these Figures is for explanatory purposes only and should not be construed as limiting.

FIG. 1 illustrates an example HMD demonstration system 10 for providing a selected lens arrangement for use by a user, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The HMD demonstration system 10 may be established by an entity implementing the subject lens dispensing system, such as a retail store, a school, a company, a hotel, a cruise ship, a sports stadium, a museum, and the like. A facility 2 containing the HMD demonstration system 10 may encompass all or part of one or more structures, such as one or more retail store buildings, one or more school buildings, one or more office buildings, etc. In FIG. 1, the facility 2 is illustrated as a retail store. The retail store may provide an inventory of devices (e.g., head-mountable devices) and/or components (e.g., lenses) to interact with so that the users can decide whether to purchase one of the devices and/or components.

As shown in FIG. 1, the HMD demonstration system 10 can include an input station 20, a dispensing station 40, a demonstration station 60, and/or a point-of-sale station 80. It will be understood that stations can be combined, for example by providing the input station 20 and the dispensing station 40 as a single station 12. It will be further understood that one or more stations can be omitted and/or located elsewhere (e.g., outside the facility 2). It will be further understood that one or more additional stations can be included.

The input station 20 can facilitate determination of a user’s need regarding corrective lenses. For example, the input station 20 can include devices that determine which of a variety of lenses are appropriate for use with a head-mountable device.

In some examples, the input station 20 can include an input device 22 that provides a user interface for inputting information regarding a given user. The input device 22 can include, for example, a touchscreen, keyboard, mouse, microphone, camera, and the like. The input device 22 can present selectable elements (e.g., from a menu) or another input format (e.g., text, handwriting, and the like). The input device 22 can also include output components, such as a display, speaker, haptic device, and the like. The input device 22 can be operated by a user or another person to input vision information relating to the user’s vision condition and/or a need for vision correction. Such information can include diagnoses, test results, prescriptions, and/or user preferences. The user can optionally input the user’s own information so that the information is not necessarily made available to another individual.

In some examples, the input station 20 can include and/or interact with a user device 24 that is the user’s own. The user device can include a phone, tablet, computer, laptop, watch, wearable device, head-mountable device, or other electronic device. Information relating to the user’s vision condition and/or a need for vision correction can be stored on or be accessible by the user device 24. Such information can include diagnoses, test results, prescriptions, and/or user preferences. The user can operate the user device 24 to authorize transmission of such information within the HMD demonstration system 10.

In some examples, the input station 20 can include a detector 32 that detects conditions of corrective lenses and/or a user. Such detections can be performed within the facility 2, so that a user need not have vision correction information prior to entering the facility 2. As shown in FIG. 1, the detector 32 can be operated to analyze existing corrective lenses, glasses, contacts, or other eyewear. The reference lenses 30 can be the user’s own and provide the appropriate vision correction needed and/or desired by the user. The detector 32 can include a camera 34 that captures images of a reference pattern 36 when viewed through the reference lenses 30. Based on the image captured by the camera 34 and the known reference pattern 36, the detector 32 can determine the effect of the reference lenses 30 and therefore the type of reference lenses 30 that are presented. Such detections can be used to determine information relating to the user’s vision condition and/or a need for vision correction.

It will be understood that the input station 20 can include other devices, such as a detector that measures one or more characteristics of the user’s own eyes to determine the user’s vision condition and/or a need for vision correction. It will be further understood that multiple input types can be combined to verify and/or confirm vision information from one type with another.

As further shown in FIG. 1, the dispensing station 40 can include a dispenser 42 that contains multiple sample lens sets 200 and dispenses a selected one or more of the sample lens sets 200. The sample lens sets 200 can include multiple types that correspond to different types of optical effects and/or vision correction. For example, each of the sample lens sets 200 can have spherical, cylindrical, and/or another type of correction. The differences in correction among multiple sample lens sets 200 can include variations in type of correction, diopter power, axis of correction, and the like. Various combinations of corrections can be combined for some or all of the sample lens sets 200. Each correction type or combination of correction types can be identified by a lens type. For example, each of the sample lens sets 200 can have a known type of correction based on the identity of the lens. Corresponding identifiers, such as stock keeping units (“SKU”), can be assigned for reference.

The selection from among the sample lens sets 200 can be based on information from the input station 20. Where a type of desired correction is determined by the input station 20, a corresponding sample lens set 200 can further be determined. For example, one of multiple sample lens sets 200 can be selected from the dispensing station 40. The selection can be based on a determination of which of the sample lens sets 200 most closely matches the information gathered at the input station 20 (e.g., diagnoses, test results, prescriptions, and/or user preferences).

It will be understood that any number of sample lens sets 200 can be provided by the dispensing station 40. However, the sample lens sets 200 provided at the dispensing station 40 can nonetheless be limited in number and therefore have discrete correction capabilities, or any two sample lens sets 200 are separated by a difference in correction. It will be further understood that the sample lens sets 200 can be provided for sampling purposes and need not precisely match the user’s vision correction needs. As such, the number of sample lens sets 200 available for sampling and for demonstration purposes can be smaller than the number of user lens sets that are available for purchase, production, and/or delivery to the user. For example, the sample lens sets 200 of the dispensing station 40 can be provided for sampling purposes, but the user can be provided with an ability to purchase custom lenses and/or lenses from a larger inventory, where different lenses are separated by smaller differences in vision correction capabilities.

As shown in FIG. 1, the dispensing station 40 can include a dispenser 42 that contains the sample lens sets 200 and provides an ability to dispense one or more of the sample lens sets 200 to a user. For example, the dispenser 42 can identify any given one of the sample lens sets 200 based on an identifier that corresponds to or is otherwise associated with the information received from the input station 20. The dispenser 42 can dispense the selected one of the sample lens sets 200 by one or more of a variety of mechanisms. For example, the dispenser 42 can indicate to a user which of the sample lens sets 200 are to be used for a given user. By further example, the dispenser 42 can move one of the sample lens sets 200 to a location accessible to the user or otherwise make such a sample lens set 200 available. Corresponding mechanisms can include actuators, belts, arms, and/or trays for moving and/or presenting the sample lens set 200 to a user. By further example, the dispenser 42 can install a selected one of the sample lens sets 200 onto a head-mountable device 100. Accordingly, the dispenser 42 can dispense both a sample lens set 200 and a head-mountable device 100 for use by the user.

Additionally or alternatively, other accessories and/or components can be dispensed for use with a head-mountable device 100. For example, the dispenser 42 or another dispenser and/or inventory source can dispense or otherwise provide accessories and/or components that are specific and/or custom for a particular user. Such accessories and/or components can include a light seal, a head securement element, and/or other equipment that is fitted to the user. Additionally or alternatively, optional equipment for use with the head-mountable device 100 can be provided based on inputs and/or user selections.

It will be understood that the dispenser 42 can provide more than one sample lens set 200 for sampling by a user. For example, multiple sample lens sets 200 that represent a range of the closest approximations of the correction needed can be provided for sampling by a user. The user can then be provided with an opportunity to sample each of the dispensed sample lens sets 200 with the head-mountable device 100 and decide which is preferred.

As further shown in FIG. 1, the HMD demonstration system 10 can further include a demonstration station 60. The demonstration station 60 can include a space and/or equipment for facilitating operation of the head-mountable device 100 (e.g., a sample head-mountable device) by a user. The demonstration station 60 can provide the head-mountable device if not previously provided (e.g., at the dispensing station 40). In the demonstration station 60, the user can operate the head-mountable device 100 with the sample lens set 200 and/or any other equipment as part of a demonstration for sampling such equipment. The user can be provided with an ability to select one or more sample lens sets 200 and/or other equipment.

As further shown in FIG. 1, the HMD demonstration system 10 can further include a point-of-sale station 80. The point-of-sale station 80 can include a point-of-sale device 82 that is operable by the user or another person to perform a transaction based on a selected one or more of the sample lens sets 200 and/or head-mountable devices 100. For example, when the user has selected a sample lens set 200 or other equipment, the user and/or another person can place an order or otherwise purchase the sample lens set 200, a head-mountable device 100, and/or other equipment. The generation of an order and/or purchase can be based on the determinations made by the input station 20 and/or user selections.

It will be understood that the sample lens set 200 and/or the head-mountable device 100 ordered and/or purchased can be other than those sampled by the user in the demonstration station 60. For example, upon completion of the demonstration at the demonstration station 60, the user can return the sample lens set 200 and/or the head-mountable device 100 to its source (e.g., the dispensing station 40). Optionally, the sample lens set 200 and/or the head-mountable device 100 can be handled by staff and/or cleansed in preparation for use by other users. When the user places the order and/or purchase, a different lens set (e.g., user lens set) and/or head-mountable device can be provided, ordered, and/or delivered to the user. As discussed herein, the user lens set that is ordered and/or purchased can be different than the one that is sampled, in that the one that is ordered and/or purchased can be more representative of the correction needs that are determined for the user. This can be made possible by providing a broader array of user lens sets for order than are available for sampling.

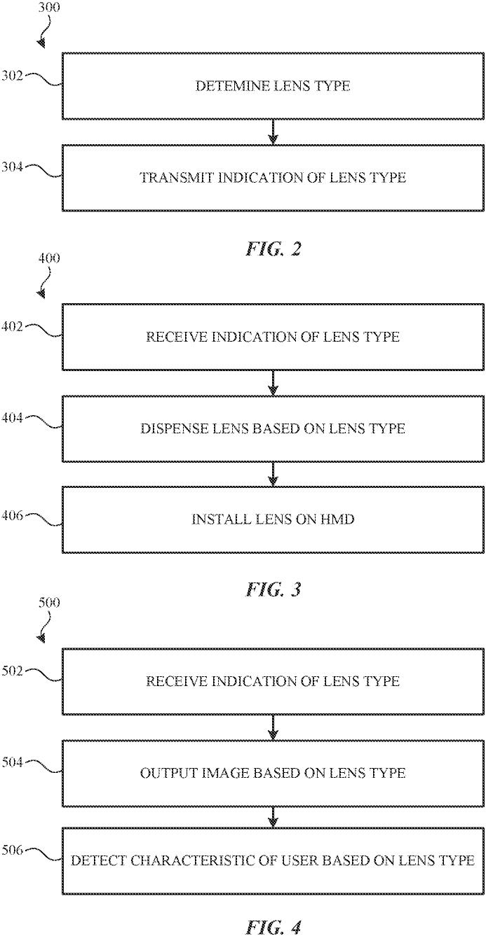

FIG. 2 illustrates a flow diagram of an example process 300 for an input device in accordance with one or more implementations. For explanatory purposes, the process 300 is primarily described herein with reference to the devices of the input station 20 of FIG. 1. However, the process 300 is not limited to the input station 20 of FIG. 1, and one or more blocks (or operations) of the process 300 may be performed by one or more other components, devices, and/or stations. The devices of the input station 20 also are presented as exemplary devices and the operations described herein may be performed by any suitable device. Further for explanatory purposes, the blocks of the process 300 are described herein as occurring in serial, or linearly. However, multiple blocks of the process 300 may occur in parallel. In addition, the blocks of the process 300 need not be performed in the order shown and/or one or more blocks of the process 300 need not be performed and/or can be replaced by other operations.

The process 300 can begin when the input station determines a lens type (302), as described herein. Such determinations can be based on user input, record retrieval, and/or direct detections of the user and/or existing corrective lenses. The input station can then transmit an indication of the lens type for dispensing an appropriate lens (304). The transmission can include the information determined and/or the identity of a lens that corresponds to the determined information.

FIG. 3 illustrates a flow diagram of an example process 400 for a dispenser in accordance with one or more implementations. For explanatory purposes, the process 400 is primarily described herein with reference to the dispenser 42 of the dispensing station 40 of FIG. 1. However, the process 400 is not limited to the dispensing station 40 of FIG. 1, and one or more blocks (or operations) of the process 400 may be performed by one or more other components, devices, and/or stations. The dispenser 42 of the dispensing station 40 also is presented as an exemplary device and the operations described herein may be performed by any suitable device. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

The process 400 can begin when the dispensing station receives an indication of a lens type (402), as described herein. The dispenser can then dispense a lens based on the lens type (404). Optionally, the dispenser can install the lens on the head-mountable device (406), and both the lens and the head-mountable device can be dispensed together.

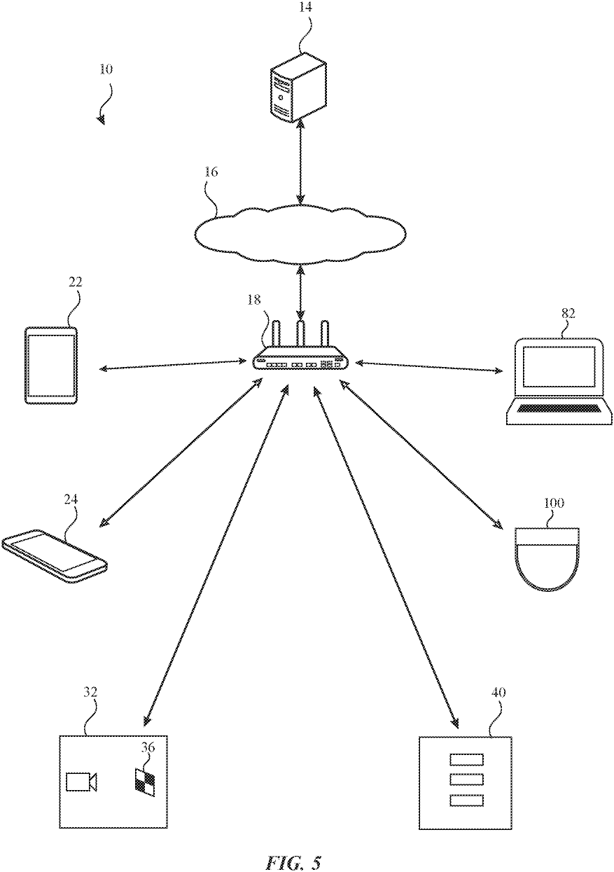

FIG. 4 illustrates a flow diagram of an example process 500 for a head-mountable device in accordance with one or more implementations. For explanatory purposes, the process 500 is primarily described herein with reference to the head-mountable device 100 of FIG. 1. However, the process 500 is not limited to the head-mountable device 100 of FIG. 1, and one or more blocks (or operations) of the process 500 may be performed by one or more other components, devices, and/or stations. The head-mountable device 100 also is presented as an exemplary device and the operations described herein may be performed by any suitable device. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

The process 500 can begin when the head-mountable device receives an indication of a lens type (502), as described herein. The head-mountable device can output an image based on the lens type (504). For example, the image displayed for observation through the lens can be altered based on the know features and characteristics of the lens. Additionally or alternatively, the head-mountable device can detect a characteristic of the user based on the lens type (506). For example, a sensor can perform detections and/or measurements based on a view through the lens. By providing an indication of the lens type to the head-mountable device, the sensor can be calibrated to interpret the view through the lens.

FIG. 5 illustrates an example network environment in which an HMD demonstration system 10 may be implemented in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment includes various devices, an access point 18, a network 16, and a server 14. The access point 18 and/or the network 16 may communicatively couple, for example, the various devices to the server 14 and/or to each other. In one or more implementations, the network 16 may be an interconnected network of devices that may include, or may be communicatively coupled to, the Internet.

The server 14 may include one or more server devices that may facilitate a service being provided to a user, such as records relating to a user’s vision information, content for use by the head-mountable device 100, and/or an order fulfillment system. In one or more implementations, the one or more service provider servers 108 may include and/or be communicatively coupled to one or more servers.

The input device 22, the user device 24, the detector 32, the dispenser 42, the head-mountable device 100, and/or the point-of-sale device 82 can include communication elements for communicating with each other. Such communication can be direct and/or indirect (e.g., via the access point 18, network 16, and/or server 14. The communication elements can include one or more wired or wireless communication elements, such as one or more universal serial bus (USB) interfaces, near-field communication (NFC) radios, wireless local area network (WLAN) radios, Bluetooth radios, Zigbee radios, cellular radios, and/or other wireless radios. In FIG. 1, by way of example, the electronic device 102 is depicted as a tablet device.

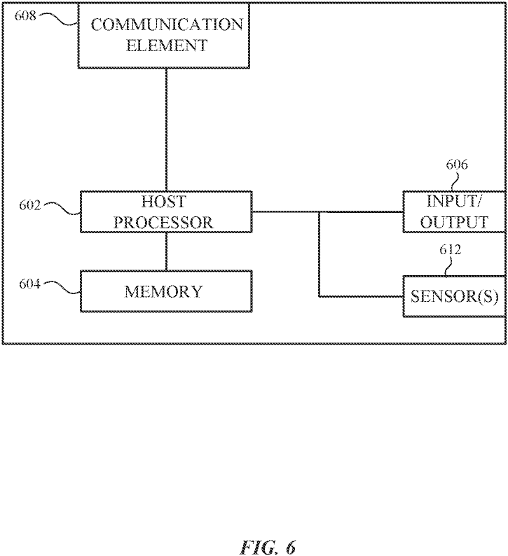

FIG. 6 illustrates an example electronic device 600 that may be used in a HMD demonstration system in accordance with one or more implementations. The electronic device 600 can correspond to the input device 22, the user device 24, the detector 32, the dispenser 40, the head-mountable device 100, and/or the point-of-sale device 82. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The electronic device 600 may include, among other components, a host processor 602, a memory 604, one or more input/output devices 606, a communication element 608, and/or one or more sensors 612.

The host processor 602, which may also be referred to as an application processor or a processor, may include suitable logic, circuitry, and/or code that enable processing data and/or controlling operations of the electronic device 600. In this regard, the host processor 602 may be enabled to provide control signals to various other components of the electronic device 600. The host processor 602 may also control transfers of data between various portions of the electronic device 600. Additionally, the host processor 602 may enable implementation of an operating system or otherwise execute code to manage operations of the electronic device 600. The memory 604 may include suitable logic, circuitry, and/or code that enable storage of various types of information such as received data, generated data, code, and/or configuration information. The memory 604 may include, for example, random access memory (RAM), read-only memory (ROM), flash, and/or magnetic storage.

The communication element 608 may include suitable logic, circuitry, and/or code that enables wired or wireless communication, such as with the access point 18, the network 16, the server 14, and/or other electronic devices of the HMD demonstration system 10. The communication element 608 of any given device can providing a communication link with the communication element of any other device within the HMD demonstration system 10. Such communication can be direct or indirect (e.g., through an intermediary). The communication element 608 may include, for example, one or more of a Bluetooth communication element, an NFC interface, a Zigbee communication element, a WLAN communication element, a USB communication element, or generally any communication element.

The one or more sensors 612 may include, for example, one or more image sensors, one or more depth sensors, one or more infrared sensors, one or more thermal (e.g., infrared) sensors, and/or generally any sensors that may be used to detect and/or measure lenses or a user.

In one or more implementations, one or more of the host processor 602, the memory 604, the one or more sensors 612, the communication element 608, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

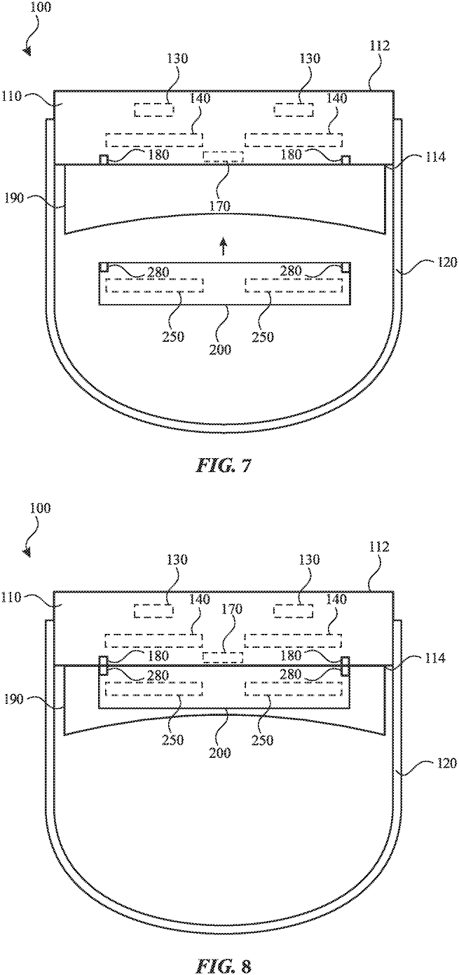

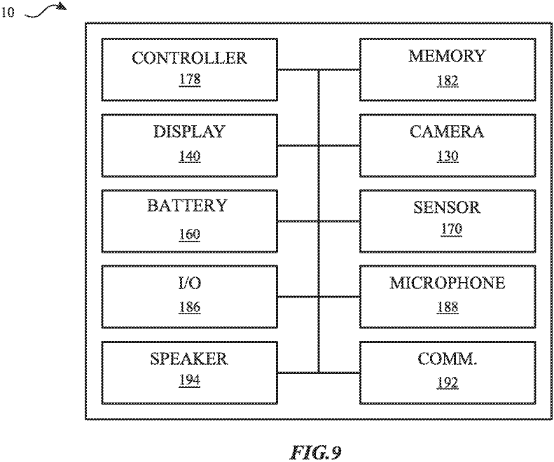

Referring now to FIGS. 7 and 8, the lens or lens device that has been dispensed can be installed for use in concert with a head-mountable device.

According to some embodiments, for example as shown in FIG. 7, a head-mountable device 100 includes a housing 110 that is worn on a head of a user. The housing 110 can be positioned in front of the eyes of a user to provide information within a field of view of the user.

The housing 110 can be supported on a user’s head with the securement element 120. The securement element 120 can wrap or extend along opposing sides of a user’s head. The securement element 120 can optionally include earpieces for wrapping around or otherwise engaging or resting on a user’s ears. It will be appreciated that other configurations can be applied for securing the head-mountable device 100 to a user’s head. For example, one or more bands, straps, belts, caps, hats, or other components can be used in addition to or in place of the illustrated components of the head-mountable device 100. By further example, the securement element 120 can include multiple components to engage a user’s head. The securement element 120 can extend from the housing 110 and/or the light seal 190.

While the light seal 190 is shown schematically with a particular size and shape, it will be understood that the size and shape of the light seal 190, particularly at the inner side of the light seal 190, can have a size and shape that accommodates the face of a user wearing the head-mountable device 100. For example, the inner side can provide a shape that generally matches the contours of the user’s face around the eyes of the user. The inner side can be provided with one or more features that allow the light seal 190 to conform to the face of the user to enhance comfort and block light from entering the light seal 190 at the point of contact with the face. For example, the inner side can provide a flexible, soft, elastic, and/or compliant structure.

While the head-mountable device 100 is worn by a user, a light seal 190 can be placed against the face and/or head of the user. The light seal 190 can include a chassis that provides structural support to one or more other components of the light seal 190. The light seal 190 can define an interior space through which light can pass, thereby providing to the user wearing the head-mountable device a view of a display element of the display elements 140. Such a view can be enhanced by preventing the ingress of light from the external environment and into the light seal 190.

Given the variety of head and face shapes that different users may have, it can be desirable to provide a light seal 190 with customization and adjustability so that the head-mountable device 100 is in a desired position and orientation with respect to the face and head of the user during use. As such, the light seal 190 can be selected and/or adjusted based on a given user. The light seal 190 can be exchanged with other light seals for accommodating a different user. It will be understood that the light seal 190 can be dispensed by the dispenser of lenses or by a different dispenser for demonstration purposes. The housing 110 and/or the light seal 190 can provide nose pads or another feature to rest on a user’s nose.

The housing 110 can provide structure around a peripheral region thereof to support any internal components of the housing 110 in their assembled position. For example, the housing 110 can enclose and support various internal components (including for example integrated circuit chips, processors, memory devices and other circuitry) to provide computing and functional operations for the head-mountable device 100, as discussed further herein. While several components are shown within the housing 110, it will be understood that some or all of these components can be located anywhere within or on the head-mountable device 100. For example, one or more of these components can be positioned within the securement element 120 of the head-mountable device 100.

The housing 110 can include and/or support one or more cameras 130. The cameras 130 can be positioned on or near an outer side 112 of the housing 110 to capture images of views external to the head-mountable device 100. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 100 can include display elements 140 that provide visual output for viewing by a user wearing the head-mountable device 100. One or more display elements 140 can be positioned on or near an inner side 114 of the housing 110. As used herein, an inner side 114 of a portion of a head-mountable device is a side that faces toward the user and/or away from the external environment.

A display element 140 can transmit light from a physical environment (e.g., as captured by a camera module) for viewing by the user. Such a display element 140 can include optical properties, such as lenses for vision correction based on incoming light from the physical environment. Additionally or alternatively, a display element 140 can provide information as a display within a field of view of the user. Such information can be provided to the exclusion of a view of a physical environment or in addition to (e.g., overlaid with) a physical environment. As used herein, a physical environment refers to a physical world that people can interact with without the aid of electronic systems. In contrast, a computer-generated reality (CGR) environment refers to a wholly or partially simulated environment that people interact with via an electronic system. Examples of CGR include virtual reality, mixed reality, and augmented reality. Electronic systems that enable a person to interact with various CGR environments include head-mountable devices, projection-based systems, heads-up displays (HUDs), vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). Rather than an opaque display, a head-mountable system may have a transparent or translucent display.

Each display element 140 can be adjusted to align with a corresponding eye of the user. For example, each display element 140 can be moved along one or more axes until a center of each display element 140 is aligned with a center of the corresponding eye. Accordingly, the distance between the display elements 140 can be set based on an interpupillary distance of the user. IPD is defined as the distance between the centers of the pupils of a user’s eyes.

The pair of display elements 140 can be mounted to the housing 110 and separated by a distance. The distance between the pair of display elements 140 can be designed to correspond to the IPD of a user. The distance can be adjustable to account for different IPDs of different users that may wear the head-mountable device 100. For example, either or both of the display elements 140 may be movably mounted to the housing 110 to permit the display elements 140 to move or translate laterally to make the distance larger or smaller. Any type of manual or automatic mechanism may be used to permit the distance between the display elements 140 to be an adjustable distance. For example, the display elements 140 can be mounted to the housing 110 via slidable tracks or guides that permit manual or electronically actuated movement of one or more of the display elements 140 to adjust the distance there between.

Additionally or alternatively, the display elements 140 can be moved to a target location based on a desired visual effect that corresponds to user’s perception of the display element 140 when it is positioned at the target location. The target location can be determined based on a focal length of the user and/or optical elements of the system. For example, the user’s eye and/or optical elements of the system can determine how the visual output of the display element 140 will be perceived by the user. The distance between the display element 140 and the user’s eye and/or the distance between the display element 140 and one or more optical elements can be altered to place the display element 140 at, within, or outside of a corresponding focal distance. Such adjustments can be useful to accommodate a particular user’s eye, corrective lenses, and/or a desired optical effect.

The head-mountable device 100 can include a sensor 170. The sensor 170 can be positioned and arranged to detect a characteristic of the user, such as facial features. For example, such a user sensor can perform facial feature detection, facial movement detection, facial recognition, eye tracking, pupil measurements, user mood detection, user emotion detection, voice detection, and the like.

As further shown in FIG. 7, a sample lens set 200 can be provided separate from and/or combinable with the head-mountable device 100. The sample lens set 200 can be or include one or more lenses 250 for providing corrective vision capabilities. It will be understood that, where multiple lenses are used, the lenses 250 of the sample lens set 200 can be provided together or separately (e.g., for combination).

As shown in FIGS. 7 and 8, attachment elements can facilitate coupling of the sample lens set 200 to the head-mountable device 100 in a relative position and orientation that aligns the lenses 250 of the sample lens set 200 in a preferred position and orientation relative to the display elements 140 of the head-mountable device 100 for viewing by the user. The head-mountable device 100 and the sample lens set 200 can be securely and releasably coupled together. For example, HMD attachment elements 180 can releasably engage lens attachment elements 280. One or more of various mechanisms can be provided to secure the components to each other. For example, mechanisms such as locks, latches, snaps, slides, channels, screws, clasps, threads, magnets, pins, an interference (e.g., friction) fit, knurl presses, bayoneting, fused materials, weaves, knits, braids, and/or combinations thereof can be included to couple and/or secure the head-mountable device 100 and the sample lens set 200 together. The components can remain secured to each other until an optional release mechanism is actuated. The release mechanism can be provided for access by a user.

As further shown in FIG. 8, the sample lens set 200 can optionally be coupled to the housing 110 while positioned within or near the light seal 190. It will be understood that the attachment elements can allow the sample lens set 200 to be securely held in any location that places the lenses 250 within a field of view of the user.

While the lenses 250 can be interposed between the user and the display elements 140, the lenses 250 can also be interposed between the sensor 170 and the user. As such, the sensor 170 can perform detections and/or measurements based on a view through the lenses 250. By providing an indication of the lens type to the head-mountable device 100, the sensor 170 can be calibrated to interpret the view through the lenses 250. For example, an image captured by the sensor 170 can be distorted somewhat by the lenses 250. Where the lens type of the lenses 250 is known, the sensor 170 can be calibrated accordingly to properly perform its detections and/or measurements.

Referring now to FIG. 9, components of the head-mountable device can be operably connected to provide the performance described herein. FIG. 9 shows a simplified block diagram of an illustrative head-mountable device 100 in accordance with one embodiment of the invention. It will be appreciated that components described herein can be provided on one, some, or all of a housing, a light seal, and/or a head securement element. It will be understood that additional components, different components, or fewer components than those illustrated may be utilized within the scope of the subject disclosure.

As shown in FIG. 9, the head-mountable device 100 can include a controller 178 (e.g., control circuity) with one or more processing units that include or are configured to access a memory 182 having instructions stored thereon. The instructions or computer programs may be configured to perform one or more of the operations or functions described with respect to the head-mountable device 100. The controller 178 can be implemented as any electronic device capable of processing, receiving, or transmitting data or instructions. For example, the controller 178 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 182 can store electronic data that can be used by the head-mountable device 100. For example, the memory 182 can store electrical data or content such as, for example, audio and video files, documents and applications, device settings and user preferences, timing and control signals or data for the various modules, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 100 can further include a display element 140 for displaying visual information for a user. The display element 140 can provide visual (e.g., image or video) output. The display element 140 can be or include an opaque, transparent, and/or translucent display. The display element 140 may have a transparent or translucent medium through which light representative of images is directed to a user’s eyes. The display element 140 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person’s retina. Projection systems also may be configured to project virtual objects into the physical environment, for example, as a hologram or on a physical surface. The head-mountable device 100 can include an optical subassembly configured to help optically adjust and correctly project the image-based content being displayed by the display element 140 for close up viewing. The optical subassembly can include one or more lenses, mirrors, or other optical devices.

The head-mountable device 100 can include one or more sensors 170, as described herein. The head-mountable device 100 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include a camera which can capture image based content of the outside world.

The head-mountable device 100 can include an input/output component 186, which can include any suitable component for connecting head-mountable device 100 to other devices. Suitable components can include, for example, audio/video jacks, data connectors, or any additional or alternative input/output components. The input/output component 186 can include buttons, keys, or another feature that can act as a keyboard for operation by the user.

The head-mountable device 100 can include the microphone 188 as described herein. The microphone 188 can be operably connected to the controller 178 for detection of sound levels and communication of detections for further processing, as described further herein.

The head-mountable device 100 can include the speakers 194 as described herein. The speakers 194 can be operably connected to the controller 178 for control of speaker output, including sound levels, as described further herein.

The head-mountable device 100 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 100 can include a battery 160, which can charge and/or power components of the head-mountable device 100. The battery 160 can also charge and/or power components connected to the head-mountable device 100.

Accordingly, embodiments of the present disclosure accommodate different users of head-mountable devices having different needs for vision correction. Systems and methods can be provided to determine the corrective lenses that are most appropriate for a given user. Such systems and methods can include an input device for determining which of a variety of existing corrective lenses are appropriate for a given user. A dispenser can provide a selected one of multiple lenses for use by a user with a head-mountable device. The head-mountable device can then be operated with the lenses, including any appropriate accommodations based on the selection of the lenses.

Various examples of aspects of the disclosure are described below as clauses for convenience. These are provided as examples, and do not limit the subject technology.

Clause A: a system comprising: a station comprising: an input device for determining a lens type for a user; a dispenser for dispensing one of multiple lens sets based on the lens type; and a station communication element configured to communicate an indication of the one of multiple lens sets; a head-mountable device comprising: a display element; an HMD attachment element configured to receive the one of multiple lens sets; and an HMD communication element configured to receive from the station communication element the indication of the lens type.

Clause B: a station comprising: a detector for measuring a characteristic of a reference lens; and a dispenser containing multiple sample lens sets, the dispenser being configured to dispense one of the multiple sample lens sets based on the characteristic of the reference lens, wherein each of the multiple sample lens sets comprises a lens attachment element configured to engage an HMD attachment element of a head-mountable device, the head-mountable device comprising a display element visible through the one of the multiple sample lens sets.

Clause C: a system comprising: an input device for determining a lens type for a user; and a dispenser comprising multiple sample lens sets, the dispenser being configured to dispense one of a number of sample lens sets based on the lens type, the sample lens sets being useable with a sample head-mountable device; and a point-of-sale device configured to generate an order for a purchasable head-mountable device and one of a number of purchasable lens sets based on the lens type, the number of purchasable lens sets being greater than the number of sample lens sets of the dispenser.

One or more of the above clauses can include one or more of the features described below. It is noted that any of the following clauses may be combined in any combination with each other, and placed into a respective independent clause, e.g., clause A, B, or C.

Clause 1: the display element is configured to output an image based on the indication of the one of the multiple lens sets.

Clause 2: the head-mountable device further comprises a sensor configured to detect a characteristic of the user through the one of the multiple lens sets based on the indication of the one of the multiple lens sets.

Clause 3: the input device is a detector for measuring a characteristic of a reference lens.

Clause 4: the detector comprises: a reference pattern; a camera configured to capture an image of the reference pattern through the reference lens; and a processor configured to: compare the image to the reference pattern; and generate the indication of the lens type based on a comparison of the image and the reference pattern.

Clause 5: the input device comprises a user interface for receiving an indication of the lens type, wherein the lens type corresponds to a prescription for the user.

Clause 6: the input device is operatively connected to the station communication element to receive an indication of the lens type from an external device, wherein the lens type corresponds to a prescription for the user.

Clause 7: the station is configured to install the one of the multiple lens sets at the HMD attachment element of the head-mountable device.

Clause 8: the detector comprises a camera and a reference pattern, wherein the camera is configured to capture an image of the reference pattern through the reference lens.

Clause 9: the detector further comprises a processor configured to compare the image to the reference pattern.

Clause 10: the dispenser is further configured to dispense multiple ones of the sample lens sets having different optical characteristics from each other, wherein one of the multiple ones of the sample lens sets is a sample lens set provides vision correction that is most similar to vision correct provided by the reference lens.

Clause 11: the dispenser is further configured to dispense the head-mountable device.

Clause 12: the dispenser is further configured to install the one of the multiple sample lens sets at the HMD attachment element of the head-mountable device.

Clause 13: the input device is operatively connected to a station communication element to receive an indication of the lens type from an external device, wherein the lens type corresponds to a prescription for the user.

Clause 14: each of the sample lens sets comprises a lens attachment element configured to engage an HMD attachment element of the sample head-mountable device, the sample head-mountable device comprising a display element visible through the one of the sample lens sets.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

In the present technology, the use of personal information data, can be used to the benefit of users. For instance, health and fitness data may be used to provide insights into a user’s general wellness, or may be used as positive feedback to individuals using technology to pursue wellness goals. The present disclosure contemplates that the entities responsible for the collection, analysis, disclosure, transfer, storage, or other use of such personal information data will comply with well-established privacy policies and/or privacy practices. Moreover, it is the intent of the present disclosure that personal information data should be managed and handled in a way to minimize risks of unintentional or unauthorized access or use.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A system comprising:
a station comprising:
an input device for determining a lens type for a user;
a dispenser for dispensing one of multiple lens sets based on the lens type; and
a station communication element configured to communicate an indication of the one of multiple lens sets;
a head-mountable device comprising:
a display element;
an HMD attachment element configured to receive the one of multiple lens sets; and
an HMD communication element configured to receive from the station communication element the indication of the lens type.

2. The system of claim 1, wherein the display element is configured to output an image based on the indication of the one of the multiple lens sets.

3. The system of claim 1, wherein the head-mountable device further comprises a sensor configured to detect a characteristic of the user through the one of the multiple lens sets based on the indication of the one of the multiple lens sets.

4. The system of claim 1, wherein the input device is a detector for measuring a characteristic of a reference lens.

5. The system of claim 4, wherein the detector comprises:
a reference pattern;
a camera configured to capture an image of the reference pattern through the reference lens; and
a processor configured to:
compare the image to the reference pattern; and
generate the indication of the lens type based on a comparison of the image and the reference pattern.

6. The system of claim 1, wherein the input device comprises a user interface for receiving an indication of the lens type, wherein the lens type corresponds to a prescription for the user.

7. The system of claim 1, wherein the input device is operatively connected to the station communication element to receive an indication of the lens type from an external device, wherein the lens type corresponds to a prescription for the user.

8. The system of claim 1, wherein the station is configured to install the one of the multiple lens sets at the HMD attachment element of the head-mountable device.

9. A station comprising:
a detector for measuring a characteristic of a reference lens; and
a dispenser containing multiple sample lens sets, the dispenser being configured to dispense one of the multiple sample lens sets based on the characteristic of the reference lens, wherein each of the multiple sample lens sets comprises a lens attachment element configured to engage an HMD attachment element of a head-mountable device, the head-mountable device comprising a display element visible through the one of the multiple sample lens sets.

10. The station of claim 9, wherein the detector comprises a camera and a reference pattern, wherein the camera is configured to capture an image of the reference pattern through the reference lens.

11. The station of claim 10, wherein the detector further comprises a processor configured to compare the image to the reference pattern.

12. The station of claim 9, wherein the dispenser is further configured to dispense multiple ones of the sample lens sets having different optical characteristics from each other, wherein one of the multiple ones of the sample lens sets is a sample lens set provides vision correction that is most similar to vision correct provided by the reference lens.

13. The station of claim 9, wherein the dispenser is further configured to dispense the head-mountable device.

14. The station of claim 13, wherein the dispenser is further configured to install the one of the multiple sample lens sets at the HMD attachment element of the head-mountable device.

15. A system comprising:
an input device for determining a lens type for a user; and
a dispenser comprising multiple sample lens sets, the dispenser being configured to dispense one of a number of sample lens sets based on the lens type, the sample lens sets being useable with a sample head-mountable device; and
a point-of-sale device configured to generate an order for a purchasable head-mountable device and one of a number of purchasable lens sets based on the lens type, the number of purchasable lens sets being greater than the number of sample lens sets of the dispenser.

16. The system of claim 15, wherein the input device is a detector for measuring a characteristic of a reference lens.

17. The system of claim 16, wherein the detector comprises:
a reference pattern;
a camera configured to capture an image of the reference pattern through the reference lens; and
a processor configured to:
compare the image to the reference pattern; and
generate an indication of the lens type based on a comparison of the image and the reference pattern.

18. The system of claim 15, wherein the input device comprises a user interface for receiving an indication of the lens type, wherein the lens type corresponds to a prescription for the user.

19. The system of claim 15, wherein the input device is operatively connected to a station communication element to receive an indication of the lens type from an external device, wherein the lens type corresponds to a prescription for the user.

20. The system of claim 15, wherein each of the sample lens sets comprises a lens attachment element configured to engage an HMD attachment element of the sample head-mountable device, the sample head-mountable device comprising a display element visible through the one of the sample lens sets.
